(19) United States
(12) Patent Application Publication
(10) Pub. No.: US 2019/0213848 A1
(43) Pub. Date: Jul. 11, 2019

(54) Method and Apparatus for Locating a Device

(71) Applicant: Nathan Chen, Milford, CT (US)

(72) Inventor: Nathan Chen, Milford, CT (US)

(73) Assignee: Nathan Chen, Milford, CT (US)

(21) Appl. No.: 15/867,578

(22) Filed: Jan. 10, 2018

(51) Int. Cl. G08B 3/10; G08B 21/24

(52) U.S. Cl. CPC G08B 3/1025; G08B 21/24

(57) ABSTRACT

The object of this invention is a unique method and apparatus for locating a lost article. In one embodiment, a target electronic device is provided. A second electronic device may also be provided and include hardware configured to receive and recognize a wireless signal and also to emit a wireless signal. A transmission medium may also be provided to facilitate communication between the target electronic device and the second electronic device. In another embodiment there may be a plurality of target electron-tic devices, second electronic devices, and transmission mediums.

### CROSS REFERENCE TO RELATED APPLICATIONS

This application claims the benefit of U.S. provisional application Ser. No. 62/444,466 filed Jan. 10, 2017.

### INCORPORATION BY REFERENCE

The above referenced application, U.S. provisional application Ser. No. 62/444,466, filed Jan. 10, 2017, is incorporated herein by reference in its entirety, including any drawings and appendices, and hereby made a part of this application.

### BACKGROUND OF THE INVENTION

The invention relates o a method and apparatus for locating a device.

It is a common problem that an item is misplaced, moved by another individual or pet, fallen in between furniture cushions, or otherwise lost and unable to be located. The current solution to such a problem is retracing one's steps, searching an area, and/or inquiring with individuals as to the item's last known location. These solutions require an undue amount of time and frequently result in the item being permanently lost. What is needed is a new and efficient method for locating missing items.

### SUMMARY OF THE INVENTION

The object of this invention is a unique method and apparatus for locating a lost article. In one embodiment, a target electronic device is provided. A second electronic device may also be provided and include hardware configured to receive and recognize a wireless signal and also to emit a wireless signal. A transmission medium may also be provided to facilitate communication between the target electronic device and the second electronic device. In another embodiment there may be a plurality of target electronic devices, second electronic devices, and transmission mediums.

Embodiments of the invention will now be described by way of example only, with reference to the accompanying drawings.

### BRIEF DESCRIPTION OF THE DRAWINGS

FIG. 1 depicts a method and apparatus or locating a device in accordance with the invention.

### DETAILED DESCRIPTION OF THE INVENTION

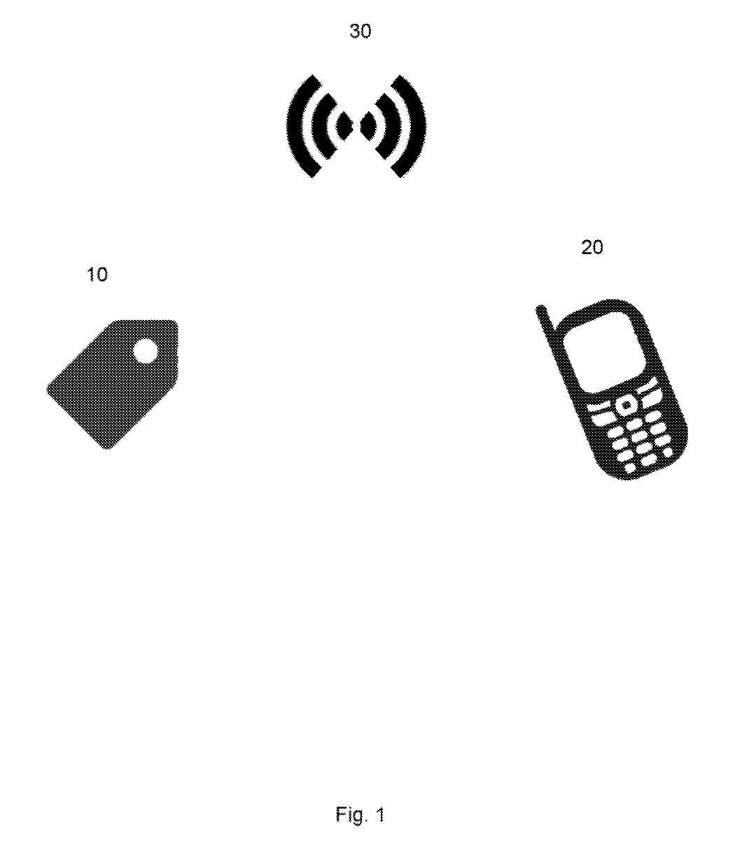

FIG. 1 shows a target electronic device 10, which includes a software in sticker or electronic chip, the sticker or electronic chip further including software for communicating with a hardware. The hardware may be configured to receive and recognize a wireless signal. The hardware may be configured to emit a wireless signal and/or an audible noise. The software is configured to instruct the hardware to emit an audible noise, a wireless signal, or both when the hardware receives a wireless signal. In one embodiment there may be a plurality of target electronic devices 10. Target electronic device 10 may be placed on any one or a number of commonly lost articles such as keys, wallets, purses, medicine bottles, cell phones, or the like.

A second electronic device 20 includes hardware configured to receive and recognize a wireless signal and also to emit a wireless signal. The second electronic device 20 hardware is configured to emit a second wireless signal when prompted. The second electronic device 20 is prompted to emit the second wireless signal when a button located on the second electronic device 20 is activated or a command is given. The button activation or command triggers the second electronic device 20 hardware to emit a second wireless signal. In one embodiment, the target electronic device 10 hardware is configured to receive the second wireless signal from the second electronic device 20. In one embodiment there may be a plurality of second electronic devices 20.

A transmission medium 30 may be included to facilitate communication between target electronic device 10 and second electronic device 20. Transmission medium 30 may be any means of facilitating communication, such as electromagnetic waves or audible waves or mechanical waves. In one embodiment communication occurs directly between target electronic device 10 and second electronic device 20 without interception by any other devices therebetween. In other words, target electronic device 10 and second electronic device 20 may communicate with one another over transmission medium 30 without the help of any other devices. In another embodiment, transmission medium 30 includes one or more access points, computers, servers, networks, cellular networks, intranets, or the Internet. In another embodiment, target, electronic device 10 may be able to communicate with other target electronic devices 10, and second electronic device 20 may be able to communicate with other second electronic devices 20. In a preferred embodiment, all devices are able to communicate with one another over transmission medium 30. Transmission medium 30 may facilitate communication according to any one or multiple communication protocols or standards such as 802.11, RFID Bluetooth®, CDMA, TDMA, FDMA, infrared, Z-Wave®, 3G, 4G, or LTE. Transmission medium 30 may communicate over any one or multiple public or privately licensed communication bands such as 900 MHz. 2.4 GHz, or 5 GHz,

When the second wireless signal is received by the target electronic device 10 hardware, the hardware communicates with the target electronic device 10 software that a wireless signal has been received. If the target electronic hardware does not recognize the second wireless signal, it does nothing. If the target electronic hardware does recognize the second wireless signal, it communicates with the target electronic device 10 software and the software is configured to instruct the hardware to emit the audible noise, which aids in the location of the target electronic device 10. The target electronic device 10 hardware is configured to emit the audible noise until the button on the second electronic device 20 is activated or a command given, instructing the second electronic device 20 to cease emitting the second wireless signal. When the second wireless signal from the, second electronic device 20 is ceased, the target electronic device 10 ceases to receive the second wireless signal. When the target, electronic device 10 hardware communicates to the target electronic device 10 software that the second wireless device is not longer being received, the target electronic device 10 software instructs the target electronic device 10 hardware to cease emitting the audible noise indicating that the target electronic device 10 was located.

In another embodiment the target electronic device 10 hardware is further configured to emit a target wireless signal. The target electronic device 10 further includes a button in communication with the target electronic device 10 hardware. When the button is activated, the target electronic device 10 hardware is configured to emit a target wireless signal that is received and recognized by the second electronic device 20 hardware. Upon receiving the target wireless signal from the target electronic device 10, the second electronic device 20 hardware communicates with the second electronic device 20 software that the target wireless signal is being received. In response to receiving the target wireless signal, the second electronic device 20 software instructs the second electronic device 20 hardware to cease emitting the second wireless signal. When the target electronic device 10 is no longer receiving the second wireless signal from the second electronic device 20, the target electronic device 10 software instructs the target device hardware to cease emitting the audible noise, indicating that the target electronic device 10 was located.

In another embodiment, multiple target electronic device 10 are each equipped with a sticker or electronic chip that is unique to that electronic device. Software is configured on the sticker or electronic chip for altering the association of the specific target device with the specific sticker or electronic chip so that any sticker or electronic chip can be paired with any target electronic device 10 The sticker is any form of indicia and is customizable through specialized software operating on a user's personal computing device. The sticker or indicia can be printed out after customization and secured to any target device.

The target electronic devices 10 each further include hardware in communication with software running on the unique sticker or electronic chip or attached to the target electronic device 10. Each unique hardware is configured to emit unique, audible noises when that hardware receives and recognizes the second wireless signal from the second electronic device 20. Each unique hardware is also configured to emit unique target wireless signals that are received and recognized by the second electronic device 20. The second electronic device 20 is configured to store in memory the unique target wireless signal that is associated with its unique target electronic device 10. The second electronic device 20 further includes hardware configured to emit multiple, unique wireless signals that are received and recognized only by a single, unique hardware associated with the sticker or electronic chip. In this embodiment, the second wireless device can be utilized to locate multiple target electronic devices 10 individually.

If a desired target electronic device 10 is out of range of a requesting second electronic device 20, transmission medium 30 may sense this and recruit further devices, servers, or computers to repeat the signal until the desired target electronic device 10 is reached. Transmission medium 30 may detect when target electronic device 10 has responded either by sensing the response directly, or by receiving a notification signal from another device, including another target electronic device 10, the requesting second electronic device 20, another second electronic device 20, or any other device connected to transmission medium 30. In such a way, Transmission medium 30 may be organized according to any one or multiple network topologies such as hub-and-spoke, ring, star, or full mesh.

In further embodiments of the invention, transmission medium 30 may include any one or more enhancement devices such as billing servers, accounting servers, satellite uplinks, or the like. Enhancement devices may be able to provide enhanced services. In one embodiment, each time a target electronic device 10 is found, its location is entered into a server database. Discovery of the location may be by target electronic device 10, second electronic device 20, or transmission medium 30 using a GPS radio or triangulation technique. Once entered into the database, a history of each target electronic device 10 may be stored and queried to determine a likely location of a lost article. In another embodiment, target electronic devices 10 may intermittently report their location to the database in order to keep its history current. Additionally, the database may be accessed by an analytics server for providing a variety of different analysis algorithms. For example, analytics server may periodically or automatically determine when an article is likely to be lost, for instance, by associating its location with being outside of the bounds of what is typical for its history. This determination may occur instantly if the target device 10 and attached article are transported outside of a given geofence, or a timer might be set to make such a determination after a given period elapses in the abnormal location. The analytics server may be configured to be in communication with a user's cell phone or email in order to alert them.

In one embodiment, transmission medium 30 may operate free of cost. In another embodiment, a billing server may be provided in order to provide a fee-for-service model. Billing server may keep track of a number of target electronic devices 10 owned by a given user in order to charge a subscription based on the number of devices, or to charge the user based on the number of times they attempt to locate a lost item, which may be referred to as lost item requests In this way, a promotional number of target electronic devices 10 or lost item requests may be packaged with another retail device or service, such as a cell phone or a cell phone plan. Users may be able to purchase a plan for further target electronic devices 10 or lost item requests. Further, target electronic devices 10 may be placed on discoverable items similar to a scavenger hunt. When all or the required number of items have been found by a contestant, servers on the transmission medium 30 may declare a winner and award a prize.

It will be appreciated that target electronic device 10, second electronic device 20, and devices on transmission medium 30 may include any necessary hardware and/or software to communicate with one another. Such hardware and/or software may include a general purpose processor or CPU, an application specific integrated circuit or ASIC, and an antenna or antennas.

1. A target electronic device, comprising:
a receiver configured to receive a second wireless signal;
a processor configured to analyze the second wireless signal and determine if it is addressed to the target electronic device;
a speaker configured to emit an audible noise if it is determined that the second wireless signal is addressed to the target electronic device; and
wherein the speaker is configured to cease emitting the audible noise is determined that second wireless signal is no longer received.

2. The target electronic device according to claim 1, further comprising:
wherein the target electronic device is attached to a personal article, such as a purse, wallet, cell phone, or keys.

3. The target electronic device according to claim 1, further comprising:
a transmitter configured to transmit a first wireless signal when it is determined that the second wireless signal is addressed to the target electronic device.

4. The target electronic device according to claim 1, further comprising:
wherein when it is determined that the second wireless signal is not addressed to the target electronic device, the processor is further configured to forward the second wireless signal.

5. The target electronic device according to claim 1, further comprising:
wherein the transmitter is further configured to periodically transmit a signal containing updated location information.

6. The target electronic device according to claim 1, further comprising:
wherein the speaker is configured to emit an audible noise indicating a low battery condition of the target electronic device.

7. A second electronic device, comprising:
a user input configured to receive an activation command;
a transmitter configured to transmit a second wireless signal addressed to a target electronic device upon receiving the activation command;
a receiver configured to receive a first wireless signal;
a processor configured to instruct the transmitter to cease transmitting the second wireless signal either upon determining that the first wireless signal is addressed to the second electronic device, or upon determining that a deactivation command is received.

8. The second electronic device according to claim 7, further comprising:
wherein the second electronic device is a stand-alone device configured solely for locating target electronic devices.

9. The second electronic device according to claim 7, further comprising:
wherein the second electronic device is a software program embedded on a user-controlled device such as a computer, laptop, or cell phone.

10. The second electronic device according to claim 9, further comprising:
wherein the user-controlled device is configured to maintain a database of information concerning one or more target device locations.

11. The second electronic device according to claim 10, further comprising:
wherein the user-controlled device is configured to analyze the database to determine automatically whether a target device is lost.

12. The second electronic device according to claim 7, further comprising:
wherein the second electronic device is configured to emit an audible noise indicating a low battery condition of the target electronic device.

13. A method for locating an article, comprising:
transmitting a second wireless signal from a second electronic device over a transmission medium;
receiving the second wireless signal by a target electronic device over the transmission medium;
determining by the target electronic device whether the second wireless signal is addressed to the target electronic device; and
if the second wireless signal is determined to be addressed to the target electronic device, emitting an audible noise by the target electronic device.

14. The method according to claim 13, further comprising:
upon receiving a user deactivation command by the target electronic device, transmitting a first wireless signal to the second electronic device;
upon receiving the first wireless signal by the second electronic device, ceasing transmission of the second wireless signal; and
upon ceasing reception of the second wireless signal by the target electronic device, ceasing emission of the audible noise by the target electronic device.

15. The method according to claim 13, further comprising:
if the second wireless signal is determined not to be addressed to the target electronic device, repeating the second wireless signal over the transmission medium.

16. The method according to claim 13, further comprising:
wherein the receiving the second wireless signal by the target electronic device over the transmission medium comprises: receiving the second wireless signal by a device on the transmission medium, processing the second wireless signal, and forwarding the second wireless signal for reception by the target electronic device.

17. The method according to claim 14, further comprising:
wherein the receiving the first wireless signal by the second electronic device comprises: receiving the first wireless signal by a device on the transmission medium, processing the first wireless signal, and forwarding the first wireless signal for reception by the second electronic device.

18. The method according to claim 17, further comprising:
wherein processing the first wireless signal comprises updating a database of target electronic device locations based on information in the first wireless signal.

19. The method according to claim 17, further comprising:
wherein processing the first wireless signal comprises accessing a billing server to determine a subscription level associated with a user of the target electronic device.

20. The method according to claim 17, further comprising:
wherein processing, the first wireless signal comprises accessing a server to determine whether a user has satisfied all requirements for completing a scavenger hunt.
